(19) United States
(12) Patent Application Publication
(10) Pub. No.: US 2022/0135003 A1
(43) Pub. Date: May 5, 2022

(54) AUTHENTICATION DEVICE, VEHICLE HAVING THE SAME, AND METHOD OF CONTROLLING THE VEHICLE

(71) Applicants: HYUNDAI MOTOR COMPANY, Seoul (KR); KIA Corporation, Seoul (KR)

(72) Inventors: Jihye LEE, Seoul (KR); Taeseung KIM, Incheon (KR); Dong June SONG, Anyang-si (KR)

(73) Assignees: HYUNDAI MOTOR COMPANY, SEOUL (KR); KIA Corporation, Seoul (KR)

(21) Appl. No.: 17/345,615

(22) Filed: Jun. 11, 2021

(30) Foreign Application Priority Data
Nov. 4, 2020 (KR) 10-2020-0146281

(51) Int. Cl. B60R 25/25; G06K 9/00; B60R 25/045; B60R 25/20; B60R 25/24; G06F 21/32; G06Q 20/40

(52) U.S. Cl. CPC B60R 25/252; G06K 9/00926; G06K 9/00087; B60R 25/045; G06Q 20/40145; B60R 25/24; B60R 25/209; G06F 21/32; B60R 25/2009

(57) ABSTRACT

An authentication device, a vehicle having the same, and a method of controlling the vehicle are provided. The device includes a recognizer configured to recognize a fingerprint of a user, a storage configured to store fingerprint information of the user, a communicator configured to communicate with a driving device of a vehicle; and a controller configured to, when the fingerprint matches the fingerprint information, transmit, to the driving device, authentication success information representing a user authentication that is valid for a first predetermined period of time, and, when the fingerprint does not match the fingerprint information, restrict fingerprint recognition for a second predetermined period of time.

### CROSS-REFERENCE TO RELATED APPLICATION

This application claims priority to and the benefit of Korean Patent Application No. 10-2020-0146281, filed on Nov. 4, 2020, the disclosure of which is incorporated herein by reference in its entirety.

### TECHNICAL FIELD

The present disclosure relates to an authentication device for authenticating a user, a vehicle having the same, and a method of controlling the vehicle.

### BACKGROUND

A vehicle may have a door locked or unlocked or ignition turned on or off by a key or a remote controller. In other words, a driver may open and close the door and the trunk, as well as starting the engine by only carrying a remote controller.

Here, the remote controller performs two-way communication with the vehicle to unlock the door or trunk of the vehicle only based on the existence of the driver adjacent to the vehicle without a separate manual operation so that the driver may open the door or trunk, and at a time of driving, allow the ignition to be turned on only in response to a start-up button being manipulated without needing to manually starting the vehicle.

In the existing technology, when the driver puts the remote controller inside the vehicle and gets off the vehicle, items inside the vehicle may be stolen or the vehicle may be stolen by others.

### SUMMARY

Therefore, the present disclosure provides an authentication device capable of performing user authentication using fingerprint information, and in response to a result of the user authentication, controlling ignition and controlling payment for an object, a vehicle having the same, and a method of controlling the vehicle.

The present disclosure also provides an authentication device capable of outputting information about a success for user authentication, a failure for user authentication, and fingerprint recognition restriction for user authentication by an image or a lamp lighting, a vehicle having the same, and a method of controlling the same.

Additional aspects of the disclosure will be set forth in part in the description which follows and, in part, will be obvious from the description, or may be learned by practice of the disclosure.

According to an aspect of the disclosure, there is provided an authentication device including: a recognizer configured to recognize a fingerprint of a user; a storage configured to store finger information of the user; a communicator configured to communicate with a driving device of a vehicle; and a controller configured to, in response to the information about the fingerprint recognized by the recognizer matching the fingerprint information stored in the storage, cause authentication success information on a user authentication that is valid for a first predetermined period of time to be transmitted to the driving device; and in response to the information about the fingerprint recognized by the recognizer mismatching the fingerprint information stored in the storage, control fingerprint recognition restriction for a second predetermined period of time.

The controller may be configured to control the fingerprint recognition restriction for the second predetermined period of time when a number of times that the information about the fingerprint recognized by the recognizer mismatches the fingerprint information stored in the storage is greater than or equal to a reference number, and control to release the fingerprint recognition restriction when the second predetermined period of time has been elapsed.

The communicator may perform communication with a terminal of the vehicle, and the controller may be configured to in response to a fingerprint registration command being received from the terminal of the vehicle and security information being received from the driving device, cause the information about the fingerprint recognized by the recognizer and the received security information to be stored in the storage.

The controller may be configured to: in response to a fingerprint deletion command and identification information of the user being received from the terminal of the vehicle, request the security information from the driving device; identifying security information corresponding to the received identification information of the user from pieces of information stored in the storage; in response to the identified security information matching the received security information received from the driving device, cause fingerprint information corresponding to the received identification information of the user from the storage; and in response to the identified security information mismatching the received security information received from the driving device, maintain the fingerprint information corresponding to the received identification information of the user from the storage.

According to another aspect of the disclosure, there is provided a vehicle including: a terminal; a driving device configured to perform ignition; a start-up button manipulated by a user; and an authentication device configured to recognize a fingerprint of the user, and in response to fingerprint information of the recognized fingerprint matching fingerprint information stored in advance, transmit authentication success information on user authentication to the driving device and the terminal, wherein the driving device controls to enter an ignition-on state in response to a manipulation signal of the start-up button being received within a first predetermined period of time after the authentication success information is received, and maintains an ignition-off state in response to the manipulation signal of the start-up button being received after the first predetermined period of time.

The authentication device may be configured to: in response to the fingerprint information of the recognized fingerprint mismatching the stored fingerprint information, confirm an authentication failure and check a number of times of the authentication failures; in response to the checked number of times of the authentication failures being greater than a reference number, restrict fingerprint recognition for a second predetermined period of time, and when the second predetermined period of time has elapsed, release the restriction on the fingerprint recognition, and the terminal may display information about the restriction on the fingerprint authentication and restriction on the ignition.

The vehicle may further include a communicator configured to perform communication with a remote controller and a user terminal, wherein the authentication device may release the restriction on the fingerprint recognition when the user authentication with at least one of the remote controller and the user terminal succeeds within the second predetermine second period of time, and the terminal may display information about the release of the restriction on the fingerprint recognition.

The vehicle may further include a communicator configured to perform communication with a plurality of the remote controllers, wherein the driving device, in response to a fingerprint registration command being received from an inputter of the terminal, may attempt a communication connection with the plurality of remote controllers, and in response to the communication connection with at least two of the plurality of remote controllers being succeeding, may transmit security information to the authentication device, and the authentication device, in response to the security information being received, may store the fingerprint information of the recognized fingerprint and the received security information.

The authentication device may be configured to: in response to a fingerprint deletion command being received from the terminal of the vehicle and security information being received from the driving device, compare the received security information with the stored security information; and in response to the received security information matching the stored security information, delete the fingerprint information stored in advance.

The vehicle may further include a recognizer provided indoors and configured to recognize the fingerprint; and a lamp part provided adjacent to the recognizer and configured to be turned on or off in response to a control command of the driving device.

The driving device may be configured to: when the communicator is in a wake-up state and ignition is in an off state, activate the authentication device; in response to an ignition command being received from at least one of the plurality of remote controllers, control ignition-on in a driving-incapable state; and in response to the fingerprint information of the recognized fingerprint matching the fingerprint information stored in advance, control to switch into a driving-capable state.

The driving device may be configured to: store an on/off state of a fingerprint ignition mode on the basis of an on/off command of the fingerprint ignition mode received by an inputter provided on the terminal; in response to the fingerprint ignition mode being stored as an off-state, control deactivation of the authentication device; and in response to the fingerprint ignition mode being stored as an on-state, control activation of the authentication device.

The driving device may be configured to: store an on/off state of a user-specific fingerprint ignition mode on the basis of an on/off command of the user-specific fingerprint ignition mode received by an inputter provided on the terminal; in response to all of the stored user-specific fingerprint ignition modes being determined to be in an off-state, control deactivation of the authentication device; and in response to at least one of the stored user-specific fingerprint ignition modes being determined to be in an on-state, control activation of the authentication device.

The terminal may communicate with a server, and in response to the authentication success information being received from the authentication device, control payment for products or services purchased through the server.

The vehicle may further include a communicator configured to perform communication with a remote controller and a user terminal, wherein the driving device, in response to an elapse time after the authentication success information is received within the first predetermined period of time, may attempt a communication connection with at least one of the remote controller and the user terminal, and in response to the communication connection being succeeding, may perform user authentication through the at least one of the remote controller and the user terminal.

According to another aspect of the disclosure, there is provided a method of controlling a vehicle, the method including: in response to a communicator being in a wake-up state and ignition being in an off state, activating an authentication device; recognizing a fingerprint of a user through the authentication device; transmitting, in response to information about the recognized fingerprint matching fingerprint information stored in advance, authentication success information of the authentication device for user authentication to a driving device; displaying ignition-capable information within a first predetermined period of time after the authentication success information is received through a terminal of the vehicle; in response to a manipulation signal of a start-up button being received within the first predetermined period of time after the authentication success information is received, turning on the ignition; in response to the manipulation signal of the start-up button being received after the first predetermined period of time, maintaining an ignition-off state; and displaying ignition restriction information corresponding to the ignition-off state through the terminal of the vehicle.

The method may further include: in response to the fingerprint information of the recognized fingerprint mismatching the stored fingerprint information, confirming an authentication failure and checking a number of times of the authentication failures; in response to the checked number of times of the authentication failures being greater than a reference number, restricting fingerprint recognition for a second predetermined period of time, and displaying information about the restriction on the fingerprint recognition through the terminal of the vehicle; and after the second predetermined period of time has elapsed, releasing the restriction on the fingerprint recognition and displaying information about the release of the fingerprint recognition restriction through the terminal of the vehicle.

The method may further include; in response to the user authentication with at least one of a remote controller and a user terminal being succeeding within the second predetermined period of time, releasing the restriction on the fingerprint recognition; in response to the user authentication with the at least one of the remote controller and the user terminal being failing within the second predetermined period of time, controlling to restrict ignition while maintaining the restriction on the fingerprint recognition; and displaying information about the restriction on the fingerprint recognition and the restriction on the ignition through the terminal of the vehicle.

The method may further include: in response to the communicator being in a wake-up state, determining whether previously stored user-specific fingerprint ignition modes are all determined to be in an off-state; in response to all of the previously stored user-specific fingerprint ignition modes being determined to be in an off-state, controlling deactivation of the authentication device; and in response to at least one of the previously stored user-specific fingerprint ignition modes being in an on-state, controlling activation of the authentication device.

The method may further include, in response to the authentication success information being received from the authentication device at a time of purchase of products or services through the terminal of the vehicle, controlling payment for the products or services purchased through a server.

### DRAWINGS

These and/or other aspects of the disclosure will become apparent and more readily appreciated from the following description of the forms, taken in conjunction with the accompanying drawings of which:

FIG. 1 is a configuration diagram illustrating a user authentication system including a vehicle in one form of the present disclosure;

FIG. 2 is an exemplary view illustrating a vehicle in one form of the present disclosure;

FIG. 3 is a control block diagram illustrating a vehicle in one form of the present disclosure;

FIG. 4 is a control block diagram illustrating an authentication device provided in a vehicle in one form of the present disclosure;

FIGS. 5A to 5C are exemplary views illustrating a start-up button provided in a vehicle in one form of the present disclosure;

FIGS. 6A and 6B are exemplary views illustrating setting and display of a fingerprint ignition mode of a vehicle in one form of the present disclosure;

FIG. 7 is a control flowchart showing a process of registering and deleting fingerprints in a vehicle in one form of the present disclosure; and

FIG. 8 is a control flowchart showing ignition control through fingerprint recognition in a vehicle in one form of the present disclosure.

### DETAILED DESCRIPTION

Like numerals refer to like elements throughout the specification. Not all elements of forms of the present disclosure will be described, and description of what are commonly known in the art or what overlap each other in the forms will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and forms of the present disclosure will be described with reference to the accompanying drawings.

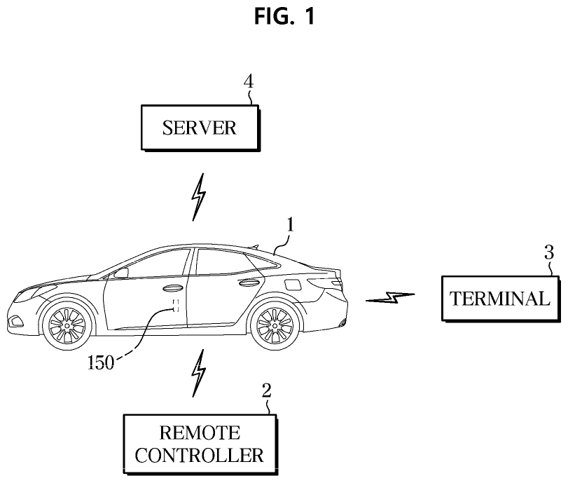

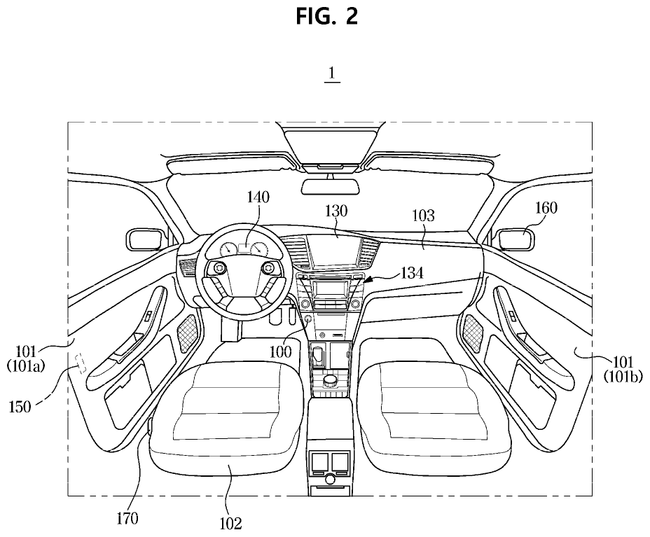

FIG. 1 is a configuration diagram illustrating a user authentication system including a vehicle in some forms of the present disclosure. FIG. 2 is an exemplary view illustrating a vehicle in some forms of the present disclosure.

FIG. 1 is an exemplary diagram illustrating an authentication system including a vehicle 1, and a remote controller 2, a user terminal 3, and a server 4 that communicate with the vehicle 1 in some forms of the present disclosure.

The vehicle 1 includes a body having an interior and an exterior of the vehicle 1 and a chassis, which is a part of the vehicle 1 except for the body, on which mechanical devices required for traveling are installed.

Referring FIG. 2, the exterior of the body includes front, rear, left and right doors 101 (101a and 101b), and window glass provided on the front, rear, left, and right doors 101 (101a and 101b) to be openable/closable.

The doors 101 (101a and 101b) and the trunk may be provided with a locking member 150 configured to perform opening/closing and locking.

The vehicle 1 may further include a side mirror 160 that provides a driver with a rear view of the vehicle 1, and may further include a mirror adjustment member (not shown) that folds or unfolds the side mirror 160.

The interior of the body of the vehicle 1 includes a seat 102 on which an occupant sits, a dashboard 103, and a head unit for receiving user input and displaying operation information of at least one electronic device.

Here, the seats 102 may be divided into a driver's seat, a passenger seat, and a rear seat according to the arrangement. Each of the seats 102 may be provided with a seat adjustment member 170 capable of adjusting the distance to the dashboard 103, the height thereof, and the angle of a backrest with respect to the dashboard 103.

The head unit may be provided with an inputter 134 for receiving operation commands and operation information of the at least one electronic device, and a display for displaying operation information of various functions that may be performed in the vehicle 1 and information corresponding to a user input.

For example, the inputter 134 may receive a user command for an audio device and an air conditioner, may receive a trunk opening/closing command, a trunk locking command and a trunk unlocking command, an opening/closing command for at least one door, a locking command for at least one door, and an unlocking command for at least one door, and may receive an operation command and operation information of a vehicle terminal.

The inputter 134 may be provided on a center fascia of the vehicle 1, and the inputter 134 provided on the center fascia and the head unit may be provided in at least one of a jog dial type, a button type, and a touch pad type.

The vehicle 1 further includes the vehicle terminal 130, such as an Audio-Video-Navigation (AVN) that performs an audio function, a video function, a navigation function, and an Internet function.

The vehicle terminal 130 may also include only a display. In this case, the vehicle terminal 130 may receive an operation command and operation information through the inputter 134 provided in the center fascia or the head unit.

The vehicle terminal 130 may be mounted on a dashboard or embedded in the dashboard.

The vehicle 1 may further include a start-up button 100. The vehicle 1, when it is determined that a user has a right to control the vehicle 1 through user authentication, activates the start-up button 100, and in response to the start-up button 100 being turned on, controls ignition.

The vehicle 1 may control ignition when the start-up button 100 is turned on during communication with the remote controller 2 or the user terminal 3, and may control on/off of ignition when fingerprint authentication of a user is successfully completed through an authentication device 110.

Here, the communication with the user terminal 3 may include performing user authentication and terminal authentication through the user terminal 3, and when the user authentication and the terminal authentication are successfully completed, identifying an electronic key stored in the user terminal 3.

The chassis may be a frame for supporting the body, and may further include a power generation device, a braking device, and a steering device for applying driving force, braking force, and steering force to the front, rear, left, and right wheels, and may further include a suspension device, a power transmission device, and the like.

The remote controller 2 may include a Fob type remote controller and a card type remote controller. Such a Fob type remote controller and a card type remote controller may perform bidirectional communication with the vehicle 1.

When the remote controller 2 is located inside the vehicle 1, the remote controller 2 may transmit, in response to a search signal from a driving device 120, an authentication signal for communication connection with the vehicle 1 to the driving device 120. That is, the remote controller 2 transmits the authentication signal for automatically communicating with the vehicle 1 in response to a signal being received from the vehicle 1, before transmitting a control signal to the vehicle 1.

When the remote controller 2 is located inside the vehicle 1, the remote controller 2 may transmit an ignition-on command and an ignition-off command to the driving device 120 on the basis of authentication success information on user authentication.

The remote controller 2, when located adjacent to the vehicle 1 outside the vehicle 1, may automatically communicate with the vehicle 1 using an antenna. In this case, the remote controller 2, in response to receiving a signal from the vehicle 1, transmits an authentication signal for automatically performing communication with the vehicle 1 using the antenna.

Here, the authentication signal of the remote controller 2 may be a signal for authenticating the remote controller 2, and may include an intensity signal corresponding to the intensity of a reception signal of the antenna of the remote controller 2.

The remote controller 2 provided as a fob type remote controller may receive a user command from a user, and upon being successfully authenticated, transmits a control signal corresponding to a received user command to the vehicle 1.

The remote controller 2 provided as a card type remote controller, upon being successfully authenticated, may transmit a control signal for unlocking the door of the driver's seat and the passenger seat of the vehicle 1 without a separate manual operation, or may transmit a control signal for ignition.

The remote controller 2 may transmit, upon being successfully authenticated and located adjacent to the vehicle 1, a control signal to turn on a light of the vehicle 1 or to unfold the side mirror 160.

That is, the remote controller 2 may transmit at least one of a control signal for door unlocking, a control signal for ignition-on, a control signal for lighting, and a control signal for folding a side mirror, in addition to the authentication signal.

The user terminal 3 may perform user registration through an application, and receive and store an electronic key of the vehicle 1. Here, the electronic key may include control right information for the vehicle 1. In the electronic key, information about the user terminal and information about the vehicle 1 may be stored.

For example, the user terminal 3 may switch the door of the vehicle 1 to a locked state or unlocked state by remotely controlling the state of the locking member 150 using the stored electronic key, may control operations of various types of electronic devices provided in the vehicle 1 using the stored electronic key, or may control ignition of the vehicle 1 using the stored electronic key.

The user terminal 3 may communicate with the vehicle 1, further receive at least one of a door locking/unlocking command, a tailgate locking/unlocking command, a lamp lighting command, and a lamp turn-off command as a user input, and transmit information corresponding to the received command to the vehicle 1. The user terminal 3 may transmit the information corresponding to the received command to the vehicle 1 as a communication signal.

The user terminal 3 may display door lock completion or failure information corresponding to the door lock command, display door unlock completion or failure corresponding to the door unlock command, display lamp lighting completion or lamp lighting failure corresponding to the lamp lighting command transmitted to the vehicle, lamp, or display a time remaining for a lamp to be turned off.

The user terminal 3 may, in response to terminal registration completion information being received from the vehicle 1, store identification information of the vehicle 1.

The user terminal 3 attempts communication connection with the vehicle 1 when performs the function of the electronic key (or a digital key) of the vehicle 1.

The user terminal 3 in some forms of the present disclosure may communicate with the vehicle 1 through at least one of a Bluetooth Low Energy (BLE) module, an Ultra-Wide Band (UWB) module, and a Near Field Communication (NFC) module.

The user terminal 3 may include an application (i.e., an App) for performing the digital key function of the vehicle 1.

The user terminal 3 may be implemented as a computer or portable terminal capable of accessing the vehicle 1 through a network.

Here, the computer may include, for example, a notebook computer, a desktop computer, a laptop PC, a tablet PC, a slate PC, and the like, which is equipped with a WEB Browser. The portable terminal may be a wireless communication device ensuring portability and mobility, and may include: all types of handheld based wireless communication devices, such as a personal communication system (PCS), a global system for mobile communications (GSM), a personal digital cellular (PDC), a personal handy phone system (PHS), a personal digital assistant (PDA), an international mobile telecommunication (IMT)-2000, a code division multiple access (CDMA)-2000, a w-code division multiple access (W-CDMA), a wireless broadband internet (WiBro) terminal, a smart Phone, and the like; and wearable devices, such as a watch, a ring, a bracelet, an ankle bracelet, a necklace, glasses, a contact lens, or a head-mounted-device (HMD).

The server 4 may store user information, vehicle terminal information, and vehicle information.

The user information may be identification information of a user registered in the server 4, fingerprint information of a user registered in the server 4, or identification information of a terminal possessed by a registered user.

Here, the identification information of the user registered in the server 4, the identification information of the terminal, etc. may be information registered through an application (an App) installed in the vehicle terminal 130 or the user terminal 3.

In addition, the user information may include the user's name, the user's home address, the user's e-mail address, the user's social security number, the user's date of birth, the user's card number or account number to perform payment for purchase, the user's driver's license Information, etc., of the user registered in the server 4.

The identification information of the user terminal includes unique identification information of the user terminal 3 that is distinguished from other terminals, and includes at least one of a phone number of the user terminal, a WIFI media access control (MAC) Address of the user terminal, a serial number of the user terminal, and an international mobile station equipment identity (IMEI) code of the user terminal.

The identification information of the user terminal may be Bluetooth identification information (BTID).

The vehicle information may include a type, a model, identification information (a license plate), a power generation method (e.g., hybrid, electric, internal combustion engine, hydrogen, etc.), a shift method, and the like of the vehicle 1.

The server 4 performs communication with the vehicle terminal 130 and the user terminal 3, and performs communication with the vehicle 1.

The server 4 allows payment control for purchase to be performed on the basis of user authentication information and purchase information received by the vehicle terminal 130, and when payment for the use of products or services is successfully completed, transmits payment information and purchase information to the vehicle 1.

The server 4 may allow a user to control the ignition of the vehicle 1 through the user terminal 3 on the basis of information on the electronic key received through the user terminal 3.

The server 4 may be a server of a company that sells products or a server of a company that provides services for user convenience and hobbies. The server 4 may be a server of a payment company that performs payments of various companies.

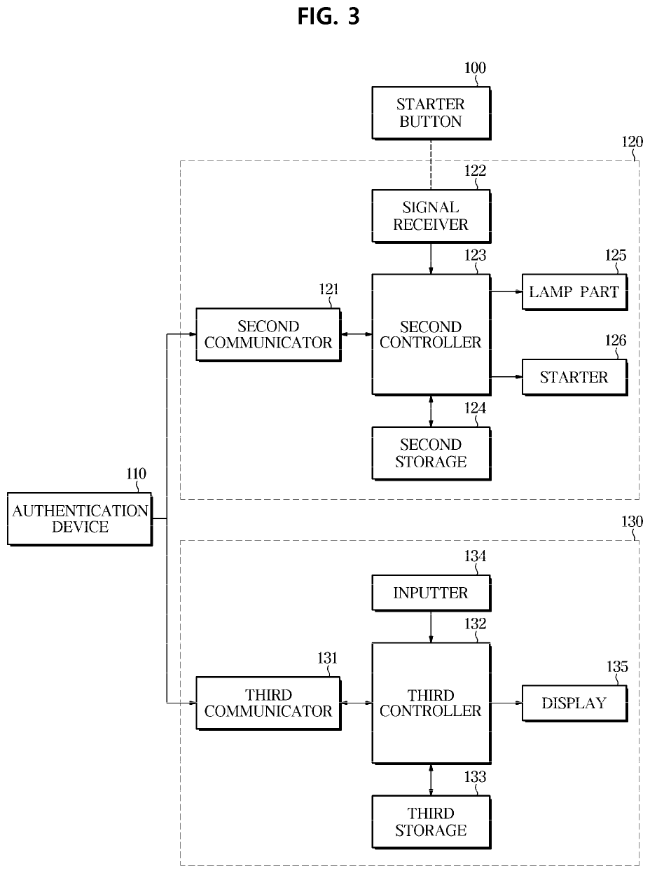

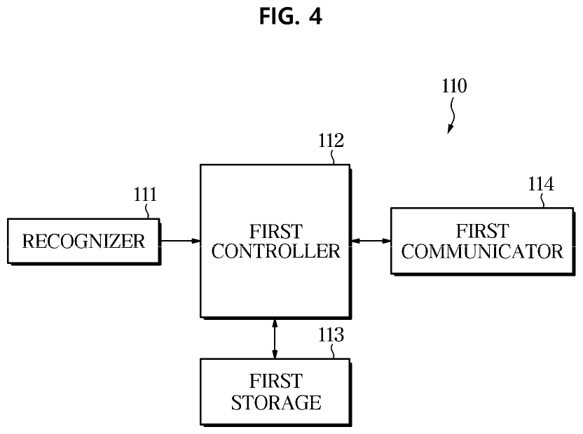

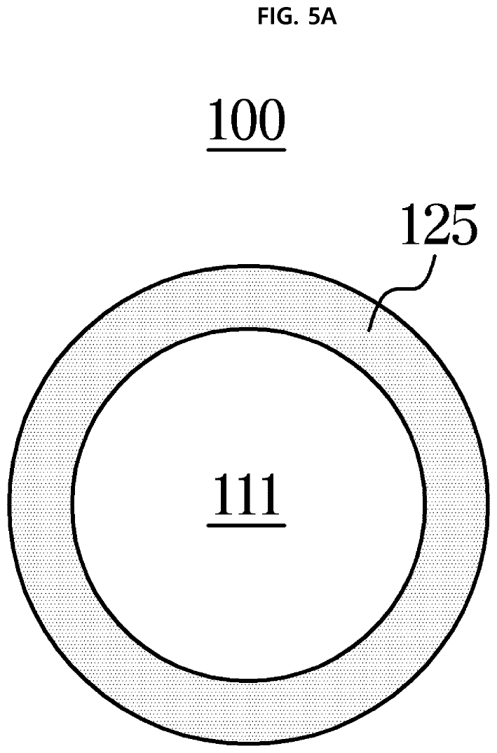

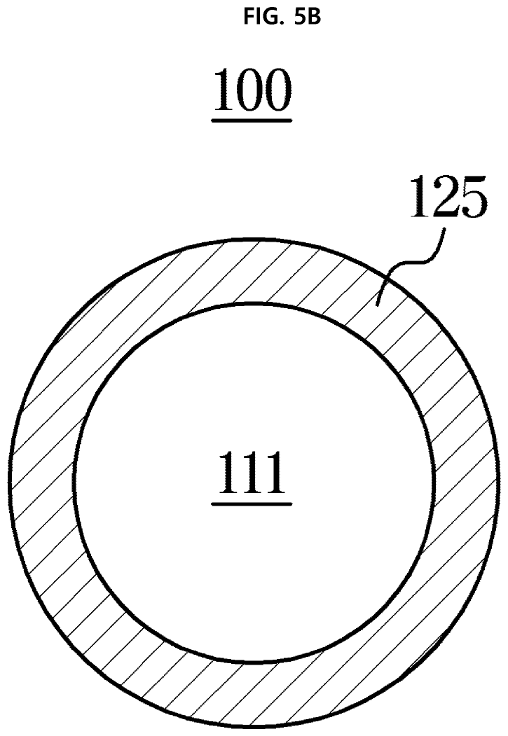

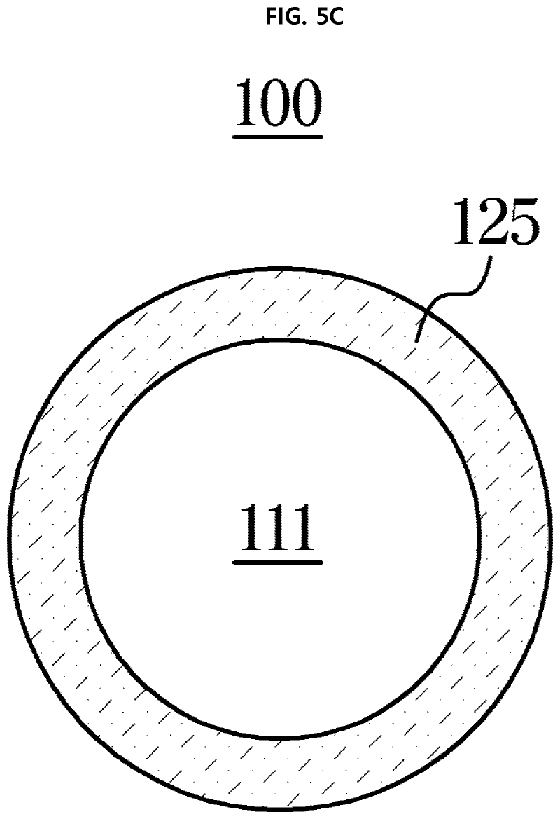

FIG. 3 is a control block diagram illustrating a vehicle in some forms of the present disclosure, FIG. 4 is a control block diagram illustrating an authentication device provided in a vehicle in some forms of the present disclosure, and FIG. 5 is an exemplary view illustrating a start-up button provided in a vehicle in some forms of the present disclosure.

Referring to FIG. 3, the vehicle may include the authentication device 110, the driving device 120, and the vehicle terminal 130.

In order to distinguish components having the same name between the authentication device 110, the driving device 120, and the vehicle terminal 130, components of the authentication device 11 may be assigned with a prefix of ‘first’, components of the driving device 120 may be assigned with a prefix of ‘second’, and components of the vehicle terminal 130 may be assigned with a prefix of ‘third’.

In addition, in order to distinguish between the terminal provided in the vehicle and the terminal possessed by the user, the terminal provided in the vehicle is described as the vehicle terminal 130, and the terminal possessed by the user is described as the user terminal 3.

Referring to FIG. 4, the authentication device 110 is a device that performs user authentication on a user who has a control right for the vehicle 1, and may include a recognizer 111, a first controller 112, a first storage 113, and a first communicator 114.

The recognizer 111 may be provided in the center fascia. The recognizer 111 may be provided on the start-up button 100.

The recognizer 111 may recognize fingerprint information on a fingerprint of a contacted finger and transmit the recognized fingerprint information to the first controller 112.

The recognizer 111 may sense a user's fingerprint for user authentication and recognize fingerprint information about the sensed fingerprint.

The recognizer 111 may include at least one of a capacitive fingerprint sensor that senses a difference in capacitance according to the bending of the fingerprint, an optical fingerprint sensor that senses the curve of the fingerprint according to the shadow of reflection of light output from a light source, and an ultrasonic fingerprint sensor that scans fine features of the skin epidermal layer.

The first controller 112 may compare fingerprint information recognized by the recognizer 111 with previously registered user fingerprint information to determine whether the fingerprint information recognized by the recognizer 111 matches the previously registered user fingerprint information, and in response to determining that the fingerprint information recognized by the recognizer 111 matches the previously registered user fingerprint information, control the first communicator 114 to transmit authentication success information on the user authentication to the driving device 120 and the vehicle terminal 130.

The first controller 112 may control deactivation of the recognizer 111 after transmitting the authentication success information.

The first controller 112, in response to determining that a manipulation signal of the start-up button 100 is not received within a first predetermined time after the authentication success information has started transmitted, may control activation of the fingerprint sensor of the recognizer 111.

The first controller 112 may receive ignition on-off information corresponding to whether a manipulation signal of the start-up button 100 has been received, from a second controller 123.

The first controller 112, in response to determining that the fingerprint information recognized by the recognizer 111 mismatches the previously registered user fingerprint information, may check the number of times of the mismatches, and in response to the checked number of times of the mismatches being greater than a reference number, may control deactivation of the finger sensor of the recognizer 111.

The first controller 112, in response to the checked number of times of the mismatches being greater than the reference number, may control restriction on fingerprint recognition. The restriction on the fingerprint recognition may include controlling deactivation of the fingerprint sensor of the recognizer 111.

The first controller 112 may control deactivation of the fingerprint sensor of the recognizer 111 for a second predetermined time from the point of time at which the last fingerprint mismatch occurs.

The first controller 112 may suspend determination on the matching of the fingerprint information recognized by the recognizer 111 for the second predetermined time from the point of time at which the last fingerprint mismatch occurs.

The first controller 112 may control activation of the fingerprint sensor of the recognizer 111 in response to determining that the second predetermined time has elapsed from the point of time at which the last fingerprint mismatch occurs.

The first controller 112 may control release of restriction on fingerprint recognition in response to authentication success information of the user terminal or the remote controller being received from the driving device 110.

The first controller 112 blocks transmission of the fingerprint information stored in the first storage 113 even when information for requesting transmission of fingerprint information is received from the driving device 120 and the vehicle terminal 130. Accordingly, the first controller 112 may prevent leakage of fingerprint information stored in the first storage 113.

The first controller 112, in response to a fingerprint registration command being received from the inputter of the vehicle terminal 130 or the inputter provided in the vehicle 1 and security information being received from the driving device 120 of the vehicle 1, may activate the recognizer 111, and may register fingerprint information recognized during the activation of the recognizer 111 as information for user authentication.

Here, the security information may be information generated by the driving device 120 when communication authentication between the second communicator 121 of the driving device 120 and the remote controller 2 is successfully completed.

In addition, the security information may be information generated by the driving device 120 when communication authentication between the second communicator 121 of the driving device 120 of the vehicle 1 and at least two remote controllers 2 is successfully completed.

The first controller 112 may register the fingerprint information recognized during the activation of the recognizer 111 together with the identification information of the user received from the vehicle terminal 130 as information for user authentication.

The first controller 112 may, in response to a fingerprint deletion command being received from the inputter of the vehicle terminal 130 or the inputter provided in the vehicle 1, delete the fingerprint information stored in the first storage 113.

The first controller 112 may, in response to the fingerprint deletion command and the user identification information from the inputter of the vehicle terminal 130 or the inputter provided in the vehicle 1, delete fingerprint information that is stored to correspond to the received identification information among pieces of fingerprint information stored in the first storage 113.

The first controller 112 may, in response to a fingerprint deletion command and identification information of a user being received from the vehicle terminal 130, request the security information from the driving device 120; identify security information corresponding to the received identification information of the user among pieces of information stored in the storage 113; in response to the identified security information matching the received security information received from the driving device 120, delete fingerprint information corresponding to the received identification information of the user from the storage 113; and in response to the identified security information mismatching the received security information received from the driving device 120, maintain the fingerprint information corresponding to the received identification information of the user.

The first controller 112 may restrict ignition control during fingerprint deletion operation in response to the fingerprint deletion command.

The first controller 112 may restrict the fingerprint recognition for the second predetermined period of time when the number of times that the information about the fingerprint recognized by the recognizer 111 mismatches the fingerprint information stored in the storage 113 is greater than or equal to a reference number; release the restriction on the fingerprint recognition after the second predetermined period of time has elapsed; and restrict ignition control for the second predetermined period of time.

The first storage 113 may store fingerprint information for user authentication.

The first storage 113 may store fingerprint information for user authentication for each user.

In this case, the first storage 113 may store the fingerprint information of the user to correspond to the identification information of the user in a table.

The first storage 113 may store the first predetermined period of time, the second predetermined period of time, and the reference number of times.

The first communicator 114 communicates with the driving device 120 and the vehicle terminal 130.

The first communicator 114 may include at least one of a wired communication module and a wireless communication module.

The first communicator 114 may include a controller area network (CAN) communication module and an Ethernet communication module. Here, the CAN communication may be a body CAN communication module.

The driving device 120 may be a device that performs driving, braking, and steering of the vehicle 1, and may be a device that controls supply of power to various components in the vehicle 1.

The driving device 120 may include a second communicator 121, a signal receiver 122, a second controller 123, a second storage 124, a lamp part 125, and a starter 126.

The second communicator 121 may communicate with the authentication device 110 and the vehicle terminal 130.

The second communicator 121 communicates with an external device through an antenna (not shown).

Here, the external device may communicate with the user terminal 3, the server 4, and the remote controller 2.

The second communicator 121 may perform at least one of Bluetooth communication, ultra-broadband communication, and near field communication (NFC) communication with the user terminal 3 performing a function of a smart key (or a digital key).

The second communicator 121 may transmit authentication information for user authentication and identification information of the vehicle 1 to the user terminal 3.

The second communicator 121 may include one or more components that enable communication between internal components in the vehicle 1, and may include, for example, at least one of a short-range communication module, a wired communication module, and a wireless communication module.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, an NFC communication module, and a Zigbee communication module.

The wired communication module may include various wired communication modules, such as a controller area network (CAN) communication module, a local area network (LAN) module, a wide area network (WAN) module, or a value added network communication (VAN) module, and various cable communication modules, such as a universal serial bus (USB) module, a high definition multimedia interface (HDMI) module a digital visual interface (DVI) module, a recommended standard-232 (RS-232) module, a power line communication module, or a plain old telephone service (POTS) module.

The wired communication module may further include local interconnect network (LIN).

The wireless communication module may include wireless communication modules supporting various wireless communication methods, such as a Wi-fi module, a wireless broadband module (Wibro) module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and the like.

The second communicator 121 may perform encrypted communication with the first communicator 114. In addition, the first communicator 114 may also perform encrypted communication with a third communicator 131.

The signal receiver 122 may receive a manipulation signal from the startup button 100 and transmit the received manipulation signal to the second controller 123. The manipulation signal of the start-up button 100 may be a touch signal or a manipulation signal by a press-in.

Here, the start-up button 100 may receive an on/off command for the ignition.

The start-up button 100, when manipulated by a user in an ignition-off station, transmits a manipulation signal regarding an ignition-on command to the signal receiver 122, and, when manipulated by a user in an ignition-on station, transmits a manipulation signal regarding an ignition-off command to the signal receiver 122.

Referring to FIG. 5, the start-up button 100 may be provided with the recognizer 111 and at least one lamp part 125. The color of the at least one lamp part 125 may be changed in response to a control command of the second controller 123.

For example, the lamp part 125 may be turned on in a first color in response to a success state of user authentication as shown in FIG. 5A, turned on in a second color in response to a failure state of user authentication as shown in FIG. 5B, and turned on in a third color in response to a fingerprint recognition restriction state of a user as shown in FIG. 5C.

The second controller 123 may control color change of the lamp part 125 on the basis of a success state and failure state for user authentication, and a fingerprint recognition restriction state.

The second controller 123 may control display of notification information displayed on at least one of the vehicle terminal 130 and the cluster 140 on the basis of an ignition-on/off state, a success state for user authentication, a failure state for user authentication, and a fingerprint recognition restriction state.

For example, the second controller 122 may, in response to determining that user authentication succeeds through a fingerprint while in an ignition-off state, display notification information stating “If the start-up button is pressed within 30 seconds, starting is performed.”

The second controller 123 may, in response to receiving a manipulation signal from the start-up button 100 without authentication information for user authentication being confirmed while in an ignition off state, control display of notification information displayed on at least one of the vehicle terminal 130 and the cluster 140.

For example, the second controller 123 may, in response to determining that a manipulation signal is received through the start-up button 100 without recognition of the remote controller 2, the user terminal 3, and fingerprint while in an ignition-off state, allow notification information stating “A vehicle key cannot be recognized.” to be displayed.

The second controller 123 may, in response to receiving a manipulation signal of the start-up button 100 multiple times without confirmation of the authentication information for user authentication while in an ignition-off state, allow notification information stating “Please directly press the start-up button with a remote controller” and “Please authenticate a user terminal or authenticate with a registered fingerprint” to be alternately displayed at a preset period of time, or allow notification information stating “Please press the start-up button after authentication of registered fingerprint” to be displayed.

The second controller 123 may, in response to determining that a user has boarded on the basis of a detection signal of an occupant detector or a door opening/closing detector in a state in which ignition is remotely turned on, allow notification information about keeping the ignition turned on.

Here, the notification information about keeping the ignition turned on may be an image stating “Please perform fingerprint authentication to keep the ignition on”.

The second controller 123 may, in response to receiving an ignition command from at least one of the plurality of remote controllers, controls ignition-on in a driving-incapable state, and in response to finger print information of a recognized fingerprint matching fingerprint information stored in advance, switches to a driving-capable state.

The second controller 123 may, in response to determining that a finger comes in contact with the recognizer 111 in the fingerprint recognition restriction state, allow an image “User authentication by fingerprint is restricted. Please try it again in XX minutes” to be displayed.

The second controller 123 may, while the second communicator 121 is in an wake-up state and the ignition is in an off state, transmit an activation command for the recognizer 111 to the authentication device 110, and in response to receiving authentication success information from the authentication device 110, allow manipulation request information of the start-up button 100 to be displayed, and count the time after the authentication success information is received to determine whether to enable ignition.

The second controller 123 may enable ignition control by controlling activation of the start-up button 100 for a first predetermined time from the point in time when the recognizer 111 starts to be activated, and in response to determining that the first predetermined time has elapsed, disable the ignition control by controlling deactivation of the start-up button 100.

The second controller 123 may, in response to receiving a manipulation signal of the start-up button 100 within the first predetermined time from the time when the authentication success information is received, control supply of power to various components in the vehicle 1.

The second controller 123 may, in response to receiving a manipulation signal of the start-up button 100 within the first predetermined time from the time when the authentication success information is received, control the ignition of the vehicle 1.

The second controller 123 may, in response to receiving a manipulation signal of the start-up button 100 within the first predetermined time from the time when the authentication success information is received, supply power to the starter 126 for starting the vehicle 1.

The second controller 123 may, in response to receiving the manipulation signal of the start-up button 100 after elapse of the first predetermined time from the time when the authentication success information is received, may control to cut off the power supply.

The second controller 123 may, when the counted time is the first predetermined time, control a communication connection with the remote controller 2 or the user terminal 3 for user authentication through the remote controller 2 or the user terminal 3.

The second controller 123 may, when the counted time is the first predetermined time, control a communication connection with the remote controller 2 for user authentication through the remote controller 2, and in response to determining that the communication connection with the remote controller 2 has failed, control a communication connection with the user terminal 3 for user authentication through the user terminal 3.

The second controller 123 may perform user authentication in the order of user authentication using the authentication device 110, user authentication using the remote controller 2, and user authentication using the user terminal 3.

The second controller 123 may, in response to user authentication through the remote controller 2 or the user terminal 3 being successfully completed in a fingerprint recognition restriction state, control to release the fingerprint recognition restriction state.

The second controller 123 may, in response to receiving identification information from the remote controller 2, compares the received identification information with the identification information stored in the second storage 124 to determine whether the remote controller 2 is a pre-registered remote controller, and in response to determining that the remote controller 2 as a pre-registered remote controller, control ignition-on of the vehicle 1 and in response to determining that the remote controller 2 is not a pre-registered remote controller, control ignition-off of the vehicle 1.

The second controller 123 may, in response to receiving an electronic key from the user terminal 3, compare the received electronic key with electronic keys stored in the second storage 124 to determine whether the user terminal 3 is a pre-registered user terminal, and in response to determining that the user terminal 3 is a pre-registered user terminal, control ignition-on of the vehicle 1, and in response to determining that the user terminal 3 is not a pre-registered user terminal, control ignition-off of the vehicle 1.

The second controller 123 allows on-off commands of user-specific fingerprint ignition modes received through the inputter to be stored in the second storage 124.

The second controller 123 may determine on/off states of the user-specific fingerprint ignition modes stored in the second storage 124, identify the driver on the basis of recognized fingerprint information, check an on/off state of the user-specific fingerprint ignition mode corresponding to the identified driver, and perform user authentication through fingerprint recognition or user authentication through communication with the remote controller 1 on the basis of the determined on/off state of the fingerprint ignition mode.

The second controller 123 may, in response to all of the user-specific fingerprint ignition modes being in an off-state, transmit a deactivation command for the recognizer 111 to the authentication device 110.

The second controller 123 may, in response to at least one of the user-specific fingerprint ignition modes being in an on-state, transmit an activation command for the recognizer 111 to the authentication device 110.

The controller 123 may, in response to at least one of the user-specific fingerprint ignition modes being in an off-state, may perform ignition-off control even when fingerprint information recognized through the authentication device 110 matches fingerprint information of the at least one user.

The second controller 123, based on reception of authentication success information, may control the operation of the locking member 150 so that the door is locked in response to receiving a door lock command, and control the operation of the locking member 150 so that the door is unlocked in response to receiving a door unlock command.

The second controller 123 may, in response to determining that the door is unlocked and the driver is on board, control activation of the recognizer 111.

The second controller 123 may determine whether the driver is on board on the basis of an occupant detector (not shown) and on the basis of whether the door is opened or closed.

The second controller 123 may, in response to identifying a user through fingerprint recognition, obtain seat adjustment information corresponding to the identified user and control an operation of the seat adjustment member 170 on the basis of the obtained seat adjustment information.

The second controller 123 performs the overall control of driving the vehicle 1.

The second controller 123 may include a memory (not shown) for storing data regarding an algorithm for controlling the operations of the components of the vehicle 1 or a program that represents the algorithm, and a processor (not shown) that performs the above-described operations using the data stored in the memory. In this case, the memory and the processor may be implemented as separate chips. Alternatively, the memory and the processor may be implemented as a single chip.

The second storage 124 may store mode information regarding an on/off state of the user-specific fingerprint ignition mode.

The second storage 124 may store identification information of one or more remote controllers, identification information of a user terminal, and information about an electronic key.

The lamp part 125 may be provided on the start-up button 100.

The lamp part 125 may be provided in the recognizer 111 or around the recognizer 111.

The lamp part 125 may be turned on in a color corresponding to the control command of the second controller 123.

The starter 126 may supply or block power to an ignition device provided in the vehicle 1 for starting the vehicle 1. For example, the ignition device may include a starting motor.

The vehicle 1 may further include a cluster 140 and a sound outputter for outputting information, such as an activation/deactivation state of the recognizer 111, an ignition-on/off state, and a user authentication failure/success state.

The vehicle terminal 130 may include a third communicator 131, a third controller 132, a third storage 133, an inputter 134, and a display 135.

The third communicator 131 may perform wired/wireless communication with the authentication device 110.

The third communicator 131 may perform CAN communication or Ethernet communication with the authentication device 110. Here, the CAN communication may be a body CAN communication.

The third communicator 131 may perform wireless communication with the server 4.

The third controller 132 may, in response to receiving authentication success information from the authentication device 110, transmits payment information to the server 4.

The third controller 132 may, in response to elapse of a first predetermined time from the time when the authentication success information is received without receiving no payment command within the first predetermined time, control to terminate a payment state, and in response to receiving a payment command within the first predetermined time, allow payment information to be transmitted to the server 4.

The third controller 132 may, in response to receiving a payment command after the first predetermined time has elapsed, control output of notification information for requesting fingerprint re-recognition.

The third controller 132 checks the number of fingerprint mismatches, and in response to the checked number of fingerprint mismatches being greater than or equal to a reference number, controls the fingerprint recognition restriction, and releases the fingerprint recognition restriction when a second predetermined time has elapsed from the time when the fingerprint recognition is restricted.

The third storage 133 may store user information, payment information, and the like.

The inputter 134 receives a user input.

The inputter 134 may receive a registration command for registering a fingerprint and a deletion command for deleting a fingerprint.

The inputter 134 may receive a command for selecting a product to be purchased or a service, a command for selecting a payment list related to discounts and installments, and a command for payment.

The service may include contents, such as music, movies, and broadcasts.

The inputter 134 may receive an on-command or an off-command of the fingerprint ignition mode, and may receive identification information of a user.

The display 135 may display a user-specific fingerprint ignition mode and may display identification information of a user.

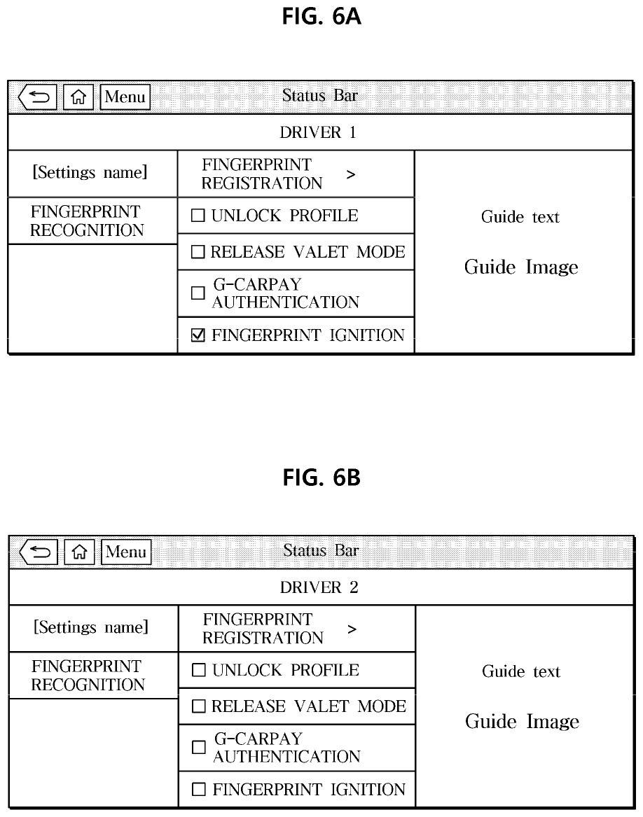

Referring to FIGS. 6A and 6B, a user may set the fingerprint ignition mode through the inputter and the display that are integrated with each other, and display the set fingerprint ignition mode.

The display 135 may display a user input received by the inputter 134 as an image.

The display 135 may display an image corresponding to online shopping, and may display an image related to payment and delivery.

The display 135 may display fingerprint recognition restriction information as an image, display authentication success information and authentication failure information as an image, and display an image of the number of authentication failures.

The display 135 may display an image of a fingerprint registration operation and a fingerprint deletion operation.

The display 135 may display an execution image when at least one of an audio function, a video function, and a navigation function is executed.

The display 135 may be provided as a touch screen integrated with the inputter 134.

At least one component may be added or omitted to correspond to the performances of the components of the authentication device 110 and the vehicle 1 shown in FIGS. 3 and 4. In addition, the mutual positions of the components may be changed to correspond to the performance or structure of the system.

Meanwhile, the components shown in FIGS. 3 and 4 may refer to a software component and/or a hardware component, such as a Field Programmable Gate Array (FPGA) and an Application Specific Integrated Circuit (ASIC).

The first, second, and third storages 113, 124, and 133 may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like., but the implementation of the first, second, and third storages 113, 124, and 133 is not limited thereto.

The first, second, and third storages 113, 124, and 133 may be a memory implemented as a chip separated from the processor, which has been described above in connection with the first, second, and third controller 112, 123, and 133, or may be implemented as a single chip integrated with the processor.

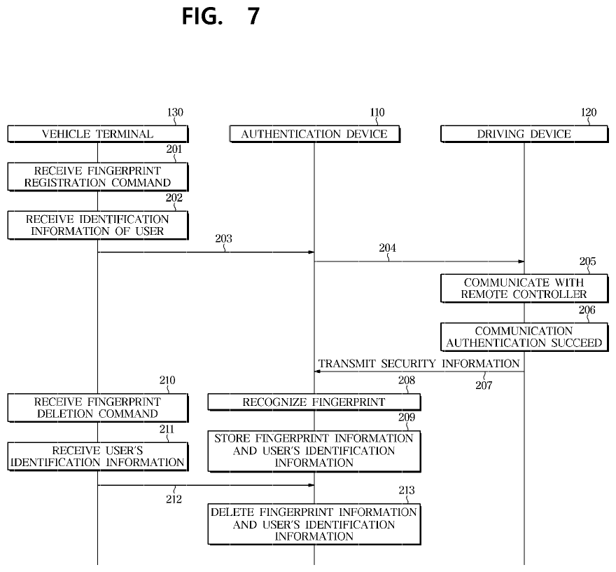

FIG. 7 is a control flowchart showing a process of registering and deleting fingerprints for a vehicle in some forms of the present disclosure.

The vehicle, in response to receiving a fingerprint registration command through the vehicle terminal 130 (201), requests input of identification information of a user through the vehicle terminal 130.

The identification information of the user may be a user's name or a number, such as user 1 and user 2.

The vehicle, in response to receiving the identification information of the user through the vehicle terminal 130 (202), transmits the received identification information of the user to the authentication device 110 (203) together with the fingerprint registration command.

The vehicle may transmit the fingerprint registration command even to the driving device 120 (204).

The vehicle, in response to receiving the fingerprint registration command from the vehicle terminal 130, performs communication with the remote controller (205). In this case, the vehicle may attempt to communicate with all remote controllers registered in the vehicle.

The vehicle attempts a communication connection with the remote controllers, and in response to communication with at least two remote controllers being successfully connected, determines that the communication authentication has been successfully completed (206), and transmit security information to the authentication device 110 (207).

The vehicle may also transmit the security information to the vehicle terminal 130. In this case, the vehicle terminal may display notification information requesting the user to bring a finger into contact with the recognizer.

The vehicle may activate the recognizer of the authentication device 110 and recognize a fingerprint of the finger that has come in contact with the recognizer (208). The vehicle may acquire fingerprint information about the recognized fingerprint and store the acquired fingerprint information together with the received user's identification information (209).

The vehicle, in response to receiving a fingerprint deletion command through the vehicle terminal 130 (210), requests input of the user's identification information through the vehicle terminal 130.

The vehicle, in response to receiving the user's identification information through the vehicle terminal 130 (211), transmits the received user's identification information to the authentication device 110 (212).

The authentication device 110 of the vehicle may search for fingerprint information corresponding to the received user's identification information among pieces of stored fingerprint information, and delete the found fingerprint information and the received user's identification information (213).

The vehicle may display information about the completion of the fingerprint information deletion through the vehicle terminal.

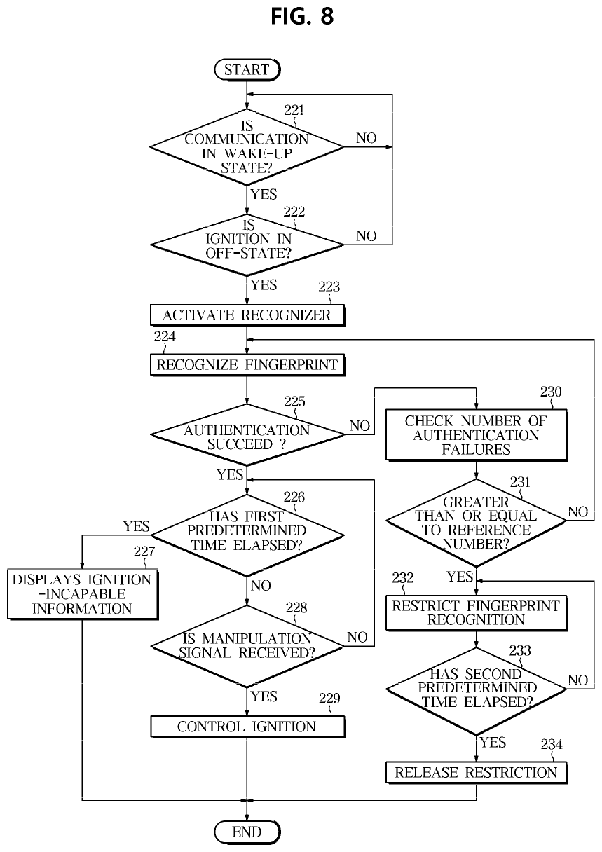

FIG. 8 is a control flowchart showing start-up through fingerprint recognition for a vehicle in some forms of the present disclosure.

The vehicle determines whether communication is in a wake-up state (221), and in response to determining that communication is in a wake-up state, determines whether the vehicle is in an ignition-off state (222).

Here, communication wake-up state may be a state in which the door is unlocked by the remote controller 2 or the user terminal 3 or a state in which the driver is on board.

The vehicle, in response to determining that communication is in a wake-up state and the ignition is in an off state, activates the recognizer of the authentication device (223).

The vehicle displays activation information of the authentication device through the vehicle terminal, and displays information for requesting a user to contact a fingerprint.

The vehicle, in response to a fingerprint being recognized through the recognizer of the authentication device (224), acquires fingerprint information about the recognized fingerprint, and compares the acquired fingerprint information with previously stored fingerprint information to determine whether an authentication has succeeded in the user authentication (225).

The vehicle may display acquisition success information about the acquired fingerprint through the vehicle terminal.

The vehicle may, in response to determining that the acquired fingerprint information matches the previously stored fingerprint information, determine that authentication has succeeded in the user authentication, and in response to determining that the acquired fingerprint information mismatches the previously stored fingerprint information, determine that authentication has failed.

The vehicle, in response to authentication being determined as succeeding in the user authentication through the authentication device, transmits authentication success information to the driving device and the vehicle terminal in the vehicle.

The vehicle, in response to authentication being determined as succeeding in the user authentication through the authentication device, turns on the lamp part in a first color.

The vehicle may display notification information for requesting manipulation of the start-up button 100 through the vehicle terminal from the time when the authentication success information is transmitted.

The vehicle counts the time from the time when the authentication success information has been transmitted.

The vehicle determines whether the time counted from the time when the authentication success information has been transmitted exceeds a first predetermined time (226), and in response to determining that the counted time exceeds the first predetermined time, displays ignition-incapable information through the vehicle terminal (227).

The counted time being exceeding the first predetermined time represents that a valid time for the user authentication has passed. In this case, fingerprint recognition may be performed again, or user authentication may be performed through a remote controller or a user terminal.

The vehicle, in response to determined that the counted time is within the first predetermined time, determines whether a manipulation signal corresponding to an ignition-on command has been received through the start-up button (228), and in response to determining that the manipulation signal corresponding to the ignition-on command has been received, controls ignition (229).

Here, the first predetermined time from the time when the authentication success information has been transmitted may represent a time during which the success on the user authentication is valid. That is, the vehicle may control the ignition when a manipulation signal is received within the valid time.

In this case, power may be supplied to various devices provided in the vehicle.

The vehicle, in response to determining that the counted time is the first predetermined time and a manipulation signal has not been received, attempts a communication connection with the remote controller. That is, the vehicle may search for a remote controller that exists in the vehicle based on attempting to connect to the remote controller.

The vehicle, in response to determining that the communication connection with the remote controller succeeds, may determine that the communication authentication with the remote controller has been successfully completed, and control the ignition through the remote controller.

The vehicle, in response to determining that the communication connection with the remote controller fails, attempts a communication connection with the user terminal.

That is, the vehicle may search for a user terminal that exists in the vehicle based on attempting to connect to the user terminal.

The vehicle, in response to determining that the communication connection with the user terminal succeeds, may determine that the communication authentication with the user terminal has been successfully completed, and control the ignition through the user terminal.

The vehicle may, in response to determining that the user authentication has failed, increase the count of the number of authentication failures

The vehicle may, in response to determining that the user authentication has failed, check the number of authentication failures (230), and determine whether the number of authentication failures is greater than or equal to a reference number (231).

In addition, the vehicle may, in response to the user authentication determined as being failed through the authentication device, turn on the lamp part in the second color.

The vehicle may, in response to determining that the number of authentication failures is less than the reference number, activate the recognizer, display authentication failure information through the vehicle terminal, and display notification information for requesting a fingerprint contact again.

The vehicle may, in response to determining that the number of authentication failures is greater than or equal to the reference number, perform control on fingerprint recognition restriction (232). In this case, the vehicle may suspend the fingerprint recognition even when the fingerprint is brought into contact with the recognizer.

The vehicle counts the time from the point in time when it is determined that the number of authentication failures is equal to or greater than the reference number, and determines whether the counted time exceeds a second predetermined time (233), and in response to determining that the counted time exceeds the second predetermined time, releases the restriction on the fingerprint recognition (234).

The vehicle may display information about the fingerprint recognition restriction and information about the remaining time until the restriction is released through the vehicle terminal.

The vehicle may, in response to a finger being brought into contact with the recognizer after the release of the restriction on the fingerprint recognition, recognize a fingerprint of the finger in contact with the recognized.

The vehicle, while the door is unlocked by the remote controller 2 or the user terminal 3 or the driver is on board, may determine whether all user-specific automatic ignition modes are in off-states, and in response to determining that all user-specific automatic ignition modes are in off-states, control deactivation of the authentication device.

The vehicle, while the door is unlocked by the remote controller 2 or the user terminal 3 or the driver is on board, may determine whether at least one of the user-specific automatic ignition modes is in an on-state, and in response to determining that at least one of the user-specific automatic ignition modes is in an on-state, may control activation of the authentication device.

The vehicle, while the door is unlocked by the remote controller 2 or the user terminal 3 or the driver is on board, may determine whether at least one of the user-specific automatic ignition modes is in an on-state, and in response to determining that at least one of the user-specific automatic ignition modes is in an on-state, may control activation of the authentication device, and in response to receiving identification information of a user, identify a fingerprint ignition mode of the user on the basis of the received identification information of the user, and in response to determining that the identified fingerprint ignition mode is in an off state, may not control ignition even when a start-up button is manipulated after success of a user authentication through a finger recognition.

Meanwhile, the disclosed forms may be embodied in the form of a recording medium storing instructions executable by a computer. The instructions may be stored in the form of program code and, when executed by a processor, may generate a program module to perform the operations of the disclosed forms. The recording medium may be embodied as a computer-readable recording medium.

The computer-readable recording medium includes all kinds of recording media in which instructions which may be decoded by a computer are stored, for example, a Read Only Memory (ROM), a Random-Access Memory (RAM), a magnetic tape, a magnetic disk, a flash memory, an optical data storage device, and the like.

As is apparent from the above, the present disclosure can authenticate a user using fingerprint information, and in response to a result of the user authentication, perform a function of controlling payment for product purchase or service provision as well as a function of controlling the vehicle ignition, thereby diversity in-vehicle functions using fingerprint information and increase the utilization thereof.

The present disclosure can control the ignition of the vehicle using other authentication devices (e.g., a smart key, a digital key, etc.) in the vehicle, thereby improving the user convenience and the reliability and accuracy of user authentication.

According to the present disclosure, fingerprint information is allowed to be registered in a security mode state, so that the vehicle is prevented from being started by an unauthorized user. Accordingly, the present disclosure may increase the security of the vehicle and prevent the vehicle from being stolen by others.

In addition, the present disclosure can be implemented only by changing software without changing hardware for user authentication, thereby preventing additional cost from incurring due to addition or manufacturing of hardware

The present disclosure can provide an enhanced security to thereby improve the quality and marketability of the vehicle, and further provide an enhanced user convenience and vehicle safety to thereby secure the product competitiveness.

Although forms of the present disclosure have been described for illustrative purposes, those skilled in the art will appreciate that various modifications, additions and substitutions are possible, without departing from the scope and spirit of the disclosure. Therefore, some forms of the present disclosure have not been described for limiting purposes.

What is claimed is:

1. An authentication device comprising:
a recognizer configured to recognize a fingerprint of a user;
a storage configured to store fingerprint information of the user;
a communicator configured to communicate with a driving device of a vehicle; and
a controller configured to:
when the fingerprint matches the fingerprint information, transmit, to the driving device, authentication success information representing a user authentication that is valid for a first predetermined period of time; and
when the fingerprint does not match the fingerprint information, restrict fingerprint recognition for a second predetermined period of time.

2. The authentication device of claim 1, wherein the controller is configured to:
restrict the fingerprint recognition for the second predetermined period of time when a number of times that the fingerprint does not match the fingerprint information is greater than or equal to a reference number; and
continue the fingerprint recognition when the second predetermined period of time has been elapsed.

3. The authentication device of claim 1, wherein:
the communicator is configured to communicate with a terminal of the vehicle, and
the controller is configured to:
when a fingerprint registration command is received from the terminal of the vehicle and security information is received from the driving device, cause the storage to store the fingerprint information and the received security information.

4. The authentication device of claim 3, wherein the controller is configured to:
when a fingerprint deletion command and identification information of the user are received from the terminal of the vehicle, request the security information from the driving device;
identify security information corresponding to the received identification information of the user from the stored information;
when the identified security information matches the received security information, cause the storage to store fingerprint information corresponding to the received identification information of the user; and
when the identified security information mismatches the received security information, cause the storage to store the fingerprint information corresponding to the received identification information of the user.

5. A vehicle comprising:
a terminal;
a driving device configured to perform ignition;
a start-up button manipulated by a user; and
an authentication device configured to:
recognize a fingerprint of the user; and
when the fingerprint of the user matches fingerprint information stored in a storage, transmit authentication success information representing user authentication to the driving device and the terminal, wherein the driving device is configured to:
enter an ignition-on state when a manipulation signal of the start-up button is received within a first predetermined period of time after the authentication success information is received; and
maintain an ignition-off state when the manipulation signal of the start-up button is received after the first predetermined period of time.

6. The vehicle of claim 5, wherein the authentication device is configured to:
when the fingerprint does not match the stored fingerprint information, confirm an authentication failure and check a number of times of the authentication failure;
when the checked number of times of the authentication failure is greater than a reference number, restrict fingerprint recognition for a second predetermined period of time; and
when the second predetermined period of time has elapsed, continue the fingerprint recognition,
wherein the terminal is configured to display information about the restriction on the fingerprint authentication and restriction on the ignition.

7. The vehicle of claim 6, further comprising:
a communicator configured to communicate with a remote controller and a user terminal,
wherein the authentication device is configured to release the restriction on the fingerprint recognition when the user authentication with at least one of the remote controller and the user terminal succeeds within the second predetermine period of time, and
wherein the terminal is configured to display information about the release of the restriction on the fingerprint recognition.

8. The vehicle of claim 5, further comprising:
a communicator configured to communicate with a plurality of the remote controllers,
wherein, the driving device is configured to:
communicate with the plurality of remote controllers when a fingerprint registration command is received from the terminal; and
when communicating with at least two of the plurality of remote controllers, transmit security information to the authentication device,
wherein the authentication device is configured to store the fingerprint information and the received security information when the security information is received.

9. The vehicle of claim 8, wherein the authentication device is configured to:
when a fingerprint deletion command is received from the terminal of the vehicle and security information is received from the driving device, compare the received security information with the stored security information; and
when the received security information matches the stored security information, delete the stored fingerprint information.

10. The vehicle of claim 8, further comprising:
a recognizer provided indoors and configured to recognize the fingerprint; and
a lamp part provided adjacent to the recognizer and configured to activate or deactivate in response to a control command of the driving device.

11. The vehicle of claim 8, wherein the driving device is configured to:
when the communicator is in a wake-up state and ignition is in an off state, activate the authentication device;
when an ignition command is received from at least one of the plurality of remote controllers, control ignition-on in a driving-incapable state; and
in response to the fingerprint matches the stored fingerprint information, switch into a driving-capable state.

12. The vehicle of claim 5, wherein the driving device is configured to:
store an on-state and an off-state of a fingerprint ignition mode based on an on-command or an off-command of the fingerprint ignition mode received by an inputter provided on the terminal;
when the fingerprint ignition mode is stored as the off-state, deactivate the authentication device; and
when the fingerprint ignition mode is stored as the on-state, activate the authentication device.

13. The vehicle of claim 5, wherein the driving device is configured to:
store an on-state and an off-state of a user-specific fingerprint ignition mode based on an on-command or an off-command of the user-specific fingerprint ignition mode received by an inputter provided on the terminal;
when all of the stored user-specific fingerprint ignition modes are determined to be in the off-state, deactivate the authentication device; and
when at least one of the stored user-specific fingerprint ignition modes is determined to be in the on-state, activate the authentication device.

14. The vehicle of claim 5, wherein the terminal is configured to:
communicate with a server; and
when the authentication success information is received from the authentication device, control payment for products or services purchased through the server.

15. The vehicle of claim 5, further comprising:
a communicator configured to communicate with a remote controller and a user terminal,
wherein the driving device is configured to:
when an elapse time after the authentication success information is received within the first predetermined period of time, communicate with at least one of the remote controller and the user terminal; and
when communicating with at least one of the remote controller and the user terminal, perform user authentication through at least one of the remote controller and the user terminal.

16. A method of controlling a vehicle, the method comprising:
when a communicator is in a wake-up state and ignition is in an off state, activating an authentication device;
recognizing a fingerprint of a user through the authentication device;
when the fingerprint matches fingerprint information stored in a storage, transmitting, authentication success information of the authentication device for user authentication to a driving device;
displaying ignition-capable information within a first predetermined period of time after the authentication success information is received through a terminal of the vehicle;
when a manipulation signal of a start-up button is received within the first predetermined period of time, activating the ignition;
when the manipulation signal of the start-up button is received, maintaining an ignition-off state; and
displaying ignition restriction information corresponding to the ignition-off state through the terminal of the vehicle.

17. The method of claim 16, further comprising:
when the fingerprint does not match the stored fingerprint information, confirming an authentication failure and checking a number of times of the authentication failures;
when the checked number of times of the authentication failures is greater than a reference number, restricting fingerprint recognition for a second predetermined period of time, and displaying information about restricting the fingerprint recognition through the terminal of the vehicle; and
after the second predetermined period of time has elapsed, releasing the restriction on the fingerprint recognition and displaying information about releasing the restriction on the fingerprint recognition restriction through the terminal of the vehicle.

18. The method of claim 17, further comprising;
when the user authentication with at least one of a remote controller or a user terminal succeeds within the second predetermined period of time, releasing the restriction on the fingerprint recognition;
when the user authentication with the at least one of the remote controller or the user terminal fails within the second predetermined period of time, restricting ignition while restricting the fingerprint recognition; and
displaying information about restricting the fingerprint recognition and restricting the ignition through the terminal of the vehicle.

19. The method of claim 16, further comprising:
when the communicator is in a wake-up state, determining whether previously stored user-specific fingerprint ignition modes are in an off-state;
when it is determined that the previously stored user-specific fingerprint ignition modes are in the off-state, deactivating the authentication device; and
when it is determined that at least one of the previously stored user-specific fingerprint ignition modes is not in the off-state, activating the authentication device.

20. The method of claim 16, further comprising:
when the authentication success information is received from the authentication device at a time of purchase of products or services through the terminal of the vehicle, controlling payment for the products or services purchased through a server.
